(19) United States
(12) Patent Application Publication
(10) Pub. No.: US 2003/0082387 A1
(43) Pub. Date: May 1, 2003

(54) Insulation facing material z-fold area coating

(76) Inventors: William R. Arndt, Hilbert, WI (US); Wallace J. Maynard, Wrightstown, WI (US)

Correspondence Address: Philip M. Weiss, WEISS & WEISS, 500 OLD COUNTRY ROAD, GARDEN CITY, NY, 11530, US

(21) Appl. No.: 10/159,912

(22) Filed: May 31, 2002

Related U.S. Application Data
(63) Continuation-in-part of application No. 10/021,184, filed on Oct. 30, 2001.

(51) Int. Cl. B05D 1/02; B32B 5/02

(52) U.S. Cl. 428/426; 427/421

(57) ABSTRACT

Insulation facing materials for use as a protective moisture barrier facing sheet (vapor retarding facing) for fiberglass and other home and commercial insulation batting used in walls and ceiling applications, and methods of making the barrier facing sheet. More particularly, the invention relates to composite coextrusion or poly coated materials used for fiberglass and other possible types of insulation, and specifically to a coating or spray applied by any well known means to the flange or z-fold area of the facing materials.

### RELATED APPLICATIONS

This is a continuation in part of U.S. patent application Ser. No. 10/021,184, filed Oct. 30, 2001.

### FIELD OF INVENTION

The present invention relates to insulation facing materials for use as a protective moisture barrier facing sheet (vapor retarding facing) for fiberglass and other home and commercial insulation batting used in walls and ceiling applications, and methods of making the barrier facing sheet. More particularly, the invention relates to composite coextrusion or poly coated materials used for fiberglass and other possible types of insulation, and specifically to a coating or spray applied by any well known means to the flange or z-fold area of the facing materials.

### BACKGROUND OF THE INVENTION

Rolls and batts of composite facing are used by most fiberglass and other insulation manufacturers to provide a moisture barrier facing and carrier sheet for adhering the insulation to ceilings and walls of commercial buildings and residential homes. These batts and rolls can be found in retail stores and packaged in various widths and lengths for consumer purchase; however, the majority of this product is sold through distributors to installers. In addition to supporting the fiberglass and other insulation materials for installation, the facing provides a moisture barrier and is printed with the R (heat resistance) factor and other information. The facing provides a barrier that prevents moisture from the warmer building from condensing into the insulation and rendering it less effective.

The facing material must also have fold retention, defined as the ability to maintain a crease. Typically, the width of pre-folded facing material is four to six inches wider than that of the fiberglass insulation, causing the facing material to extend two to three inches beyond the width of the fiberglass on both sides. The strips of the facing material that extend beyond the width of the fiberglass are known as the z-fold areas or flanges. These z-fold areas or flanges are folded lengthwise toward the printed side of the facing material, with the fold abutting the outer edge of the insulation material. The flange is again folded in half lengthwise in the opposite direction approximately one to two inches from the first fold. This double fold forms an accordion pattern, or a double fold in the shape of the letter ‘z’, creating a two- to three-inch folded flange or z-fold area. This folded flange is pulled open by insulation installers to serve as nailer tabs, which is the area on the facing material through which nails or staples are driven to install the insulation to ceilings or walls.

During the rolling process using a hot roll, when the insulation is adhered to the facing material, the coating becomes tacky enabling the insulation to stick to the facing material. The hot rolling process also causes the coating on the flange or z-fold areas to become tacky, making the z-fold stick together and difficult for insulation installers to open. Some manufacturers also want to manufacture varying widths of insulation materials and open up the flange or z-fold areas to provide this extra width when rolling or installing the insulation. Because the hot rolling process also causes the z-fold or flange areas to become tacky, manufacturers have found it difficult to unfold the flanges or z-folds in order to process larger widths of insulation materials.

U.S. Pat. No. 6,357,504 relates to an insulation product which includes an elongated batt of fibrous insulation material, and a facing adhered to a major surface of the batt. The facing is a coextruded polymer film of barrier and bonding layers, with the bonding layer having a softening point lower than the softening point of the barrier layer. The bonding layer can include one or more of ethylene N-butyl acrylate, ethylene methyl acrylate, low density polyethylene and ethylene ethyl acrylate. When the facing has been heated to a temperature above the softening point of the bonding layer, but below the softening point of the barrier layer, the facing is adhered to the batt by the attachment of the bonding layer to the fibers in the batt due to the softening of the bonding layer. The insulation product can be singly faced or doubly faced, and the edges of the double facing can be joined to form an encapsulated product. The facing has no flanges.

In a further embodiment of this patent, the bonding layer is selected so that the flanges formed from it will bond together when overlapped. When a flanged insulation product is installed in a studded wall cavity, the flanges are typically stapled to the studs. A stud located between neighboring cavities will typically have the flange from the insulation in one cavity stapled over the top of a flange from the insulation in the other cavity. The coextruded film facing can be formulated so that the bonding layers, over time due to the pressure of the overlying gypsum wallboard, will bond together when overlapped.

Also the insulation products incorporating the coextruded film facing eliminates the need for such a discrete barrier because the individual facings bond together, especially if the overlapped flanges are heated with a heat gun or heated roll. The bonding layer can be formulated to be slightly tacky when cooled so as to enhance the attachment of the overlapped flanges.

U.S. Pat. No. 5,979,131 relates to an exterior insulation and finish system produced for exterior construction having a primary weather proofing layer formed by a finish coat and a secondary seal provided intermediate of the various layers of exterior insulation between a sheathing substrate and insulation board. The secondary seal layer also serves to adhesively secure the insulation board to the sheathing substrate.

U.S. Pat. No. 4,970,842 relates to a sealing device for sealing an air barrier membrane to a wall, particularly to a wall having masonry anchors projecting outwardly therefrom. The device includes a flat pre-formed member which can engage sealingly to the masonry tie anchors and which has surface means for sealingly securing the air barrier membrane thereto.

U.S. Pat. No. 4,151,692 relates to a T-shaped batt of insulation with a U-shaped vapor barrier covering the lower surface of the batt. The vapor barrier, which extends beyond the ends of the batt is used to connect consecutive batts. The T-shaped batts are installed by rolling them between parallel structural members so that the horizontal flange sections of the T-shaped batts overlap atop the structural members.

U.S. Pat. No. 4,709,523 relates to an insulation batt which has a facing flange, the facing flange having pressure-sensitive adhesive thereon and being folded inwardly to engage the pressure sensitive adhesive with a release strip on the inside of the facing and dispose the facing flange flush with an edge of the batt. For installation of the batt, the facing flange is unfolded outwardly to expose the pressure-sensitive adhesive. A facing material comprises a sheet coated on one side with a hot melt laminating adhesive such as asphalt. Opposite longitudinal edge portions are inwardly folded through 180 degrees to provide a pair of double-thickness facing flanges. Pressure sensitive adhesive is applied to the facing flanges and release strips are adhered to the sheet by the laminating adhesive adjacent the facing flanges. Each of the release strips has a coating of release agent on a surface thereof facing the pressure sensitive adhesive. The facing material is adhered to a major surface of a fibrous insulation batt by the portion of laminating adhesive disposed between the release strips. After application of the facing material to the batt, the laminating adhesive cools and hardens.

U.S. Pat. No. 4,952,441 relates to a thermal insulation batt which is comprised of a layer of bulk thermal insulation material; a vapor impervious thermoplastic facing sheet adhesively bonded to the layer of insulation material; paper tabs containing a fold line securely attached along each of longitudinal sides of the facing sheet or by having dual foldable paper strips enclosed within a folded back portion of the facing sheet so as to provide a deadfold characteristic for the tabs. The insulation batts are packaged with the dual tabs folded downwardly adjacent the facing sheet, and at installation the dual tabs are folded outwardly without snapback and are attached onto spaced apart structure members such as studs of a wall. Deadfold characteristics refer to the property of the tab to be folded into a given position and remain in that position until it is folded into another position. The thermal insulation batts are comprised of a layer of a bulk insulation material such as fiberglass, mineral wool or the like and a vapor-impervious facing in the form of a thin thermoplastic film which is adhesively bonded to the insulation layer. The facing sheet is made of polyethylene, polycarbonate and polyethylene terephalate. The adhesives are water based acrylic resins.

U.S. Pat. No. 5,421,133 relates to an insulation product comprising an elongated blanket of fibrous insulation material having a facing on one major surface, the facing extending beyond the edges of the blanket to form opposed flanges, the flanges having first reinforcement fibers extending longitudinally along the outer edge zones of the flanges, and the flanges having intermediate zones positioned inwardly of the outer edge zones. The product is provided with second reinforcement fibers of a lesser density so as to provide a visual indication of the boundary between the outer edge zones and the intermediate zones of the flanges. The facing extends beyond the edges of the insulation to form flanges for attachment to joists to ceiling structures.

U.S. Pat. No. 5,922,626 relates to a self-adhering tape-like or fibrous reinforcing material which consists of laminates of at least two or more coextruded layers of at least one high-temperature stable plastic material (A) and at least one low-melting plastic material (B). The low-melting plastic material (B) has self-adhering binder properties whereas the high-temperature stable plastic material (A) is suitable for conferring increased strength properties to nonwoven textile fabrics, in particular in the automobile area.

U.S. Pat. No. 5,746,854 relates to a method of manufacturing/making mineral fiber (e.g., fiberglass) thermal insulation batt wherein a base mineral fiber layer is impregnated with a two-layer layering system so as to produce a batt which is substantially vapor impermeable with a perm vapor rating less than about one. The first layer of the layering system is of a low melt material while the second layer is of a high melt material, the first layer being sandwiched between the base insulating layer, and functioning to bond the layering system to the base.

U.S. Pat. No. 5,733,624 relates to a mineral fiber (e.g. fiberglass) thermal insulation batt wherein a base mineral fiber layer is impregnated with a two-layer layering system so as to produce a batt which is substantially vapor impermeable with a perm vapor rating less than about one. The first layer of the layering system is of a low melt material while the second is of a high melt material, the first layer being sandwiched between the base insulating layer and the second layer, and functioning to bond the layering system to the base. This patent relates to a coex film of low density resin with EVA and high density. This product is coextruded right onto the fiberglass batt in-line. It is referred to as impregnated right into the fiberglass.

U.S. Pat. No. 6,221,464 relates to an insulation assembly which includes an elongated batt of fibrous insulation material having two opposed major surfaces, where the batt has a first facing secured on its first major surface. The first facing extends beyond the side edges of the batt to form opposed flanges suitable for attaching the insulation assembly to a building structure. The batt has a second facing secured on its second major surface, with the second facing extending beyond the side edges of the batt to form opposed flanges suitable for attaching the insulation assembly to a building structure. The method of making an insulation assembly includes, moving a pack of fibrous insulation material along a path, where the fibrous insulation material has two opposed major surfaces. A continuous encapsulation material is applied to the pack, and a portion of the encapsulation material is continuously gathered to form a two part fold. The two parts of the fold are bonded together to form a flange suitable for attaching the insulation assembly to a building structure.

U.S. Pat. No. 6,191,057 relates to an insulation product which includes an elongated batt of fibrous insulation material, and a facing adhered to a major surface of the batt, wherein the facing is a coextruded polymer film of barrier and bonding layers, with the bonding layer having a softening point lower than the softening point of the barrier layer, with the bonding layer being one or more materials of the group consisting of ethylene N-butyl acrylate, ethylene methyl acrylate and ethylene ethyl acrylate. The facing is heated to a temperature above the softening point of the bonding layer, but below the softening point of the barrier layer, whereby the facing is adhered to the batt by the attachment of the bonding layer to the fibers in the batt due to the softening of the bonding layer.

### SUMMARY OF THE INVENTION

The present invention relates to a coextruded coated paper material comprising; a first layer comprising paper; a second layer comprising a polymer resin material; and a third outside sealant layer comprising a low melt polymer resin; wherein all three layers are integrally bonded together. The present invention also relates to a poly coated paper material comprising: a first layer comprised of paper; a second layer comprised of poly and/or a third layer also comprised of poly. The present invention further relates to a coating or spray that is applied by any well known means to the flange or z-fold areas of the above facing materials so as to prevent tackiness during the hot rolling process and. installation of the insulation. It is an object of the present invention for the coating or spray applied to the flange or z-fold areas to prevent the adhesion of the folded areas during the hot rolling process and during the installation of the insulation material. It is an object of the present invention for the coating to be applied or sprayed by an air jet, sponge, or other well known means of application.

It is an object of the present invention for the first layer to comprise cellulosic material having a basis weight of about 30-55 lbs./3,000 sq. ft. It is an object of the present invention for the first layer to comprise a cellulosic material having fold retention, defined as the ability to maintain a crease.

It is an object of the present invention for the first layer of coextruded material to comprise a primed or unprimed cellulosic material selected from the group consisting of machine finished paper, machine glazed paper or extensible paper. It is an object of the present invention for the second layer of the coextruded material to comprise a polymer resin selected from the group consisting of high density polyethylene, polypropylene or linear low density polyethylene. It is an object of the present invention for the third layer of the poly coated or coextruded material to comprise a polymer resin material selected from the group consisting of low density, high melt index polyethylene that can be flame- or corona-(electrically) treated to enhance adhesion or bonding to fiberglass or other insulation.

It is an object of the present invention for the first layer of the poly coated material to comprise a cellulosic material consisting of machine finished paper, machine glazed paper, or extensible paper. It is an object of the present invention for the second and third layers (if a third layer is present) to comprise a poly material.

It is an object of the present invention for the coating or spray on the flange or z-fold areas to comprise a starch, silicone, mineral oil, or other contaminant applied by any well known means to the flange or z-fold areas of the poly coated and the coextruded facing material.

It is an object of the present invention for the poly coated or the coextruded material to be faced with a roll or batt of insulation. It is an object of the present invention for the poly coated or the coextruded material to provide a barrier to effectively prevent moisture absorption into the insulation.

It is an object of the present invention for the coating or spray on the flange or z-fold area to prevent tackiness and adhesion of the z-folds during both the hot rolling process when the poly coated or coextruded material is faced with a roll or batt of insulation, and during the installation process when the z-fold area is pulled open to serve as a nailer tab.

The present invention relates to a process for making a composite material comprising: providing a first sheet of cellulosic material and a second poly coated or coextruded layer comprising two layers of polymer resin materials. The poly coated or coextrusion layers are applied to the surface of the first sheet. The first and second poly coated or coextrusion layers are conveyed into a laminating apparatus where the layers are bonded to form an integral composite material.

The present invention relates to poly coating or to co-extrusion of ethylene-based materials to be part of a paper substrate structure used for insulation facing. Fiberglass and other insulating type materials are incorporated with the poly coated or the coextruded substrate, laminated to the ethylene surface to form a composite product used in the building industry. The paper substrate has a release characteristic which, during the process of creating the poly coated or the coextruded material, does not stick to the drum like film. Further, paper does not melt.

It is an object of the present invention to provide a thin moisture barrier coating that allows maximum footage at normal roll diameters and meets or exceeds the moisture barrier specifications. These results can be measured by MVTR (moisture vapor transmission rates) and actual roll diameters versus footage on the roll.

The poly coated process of the present invention comprises applying or coating one or two layers of poly to one side of the paper substrate. The coextrusion process of the present invention comprises applying two different resins, simultaneously, to one side of a paper. One resin has low moisture transmission rates (WVTR test values of 0.50 or less versus 1.00 with a single LPDE layer of comparable thickness). The other layer provides the low temperature (100 degrees Celsius or less) seal strength required for good adherence to fiberglass or other insulation product. This composite coextruded product provides the desired improvements at the same or lower cost to the fiberglass or other insulation producer.

The present invention also relates to application of a coating or spray to the z-fold or flange area of the composite facing material comprising: applying or spraying a coating or spray by any well known means to the z-fold or flange area of the composite facing material prior to the hot rolling process by which insulation manufacturers adhere the insulation to the facing material. The present invention comprises applying starch, silicone, mineral oil, or other substance by any well known means to the z-fold or flange area of the composite facing material. The coating or spray of starch, silicone, mineral oil, or other substance prevents tackiness in the flange area during the hot rolling process, enabling manufacturers to accommodate larger widths of insulation and installers to easily open the z-folds during installation.

### BRIEF DESCRIPTION OF THE DRAWINGS

FIG. 1 is a cross-sectional view of the coextrusion layer as applied to paper.

FIG. 2 is a schematic view of an apparatus used to produce the coextrusion material of FIG. 1.

FIG. 3 is a cross-sectional view of the z-fold or flange area of composite facing material produced in accordance with the present invention.

### DETAILED DESCRIPTION OF THE DRAWINGS

FIG. 1 shows an embodiment of the coextrusion material of the present invention. The composite wrap material 10 is made of a first layer 15 composed of a cellulosic material, a layer 20 composed of a polymer film material, and a second polymer layer 25 positioned on top of the first layer. The wrap material 10 is attached to fiberglass or other insulation 28.

The first layer 15 of the wrap material 10 can be made of any material composed primarily of cellulosic fibers. Suitable materials for use as the first layer 15 include, for example, machine finished or machine-glazed paper, extensible paper or other types of paper. An exemplary material for the first layer 15 is paper with a basis weight of about 30-55 lbs. per 3,000 sq. ft.

The initial inside layer 20 of the coextrusion material 10 is a polymer resin that, when applied to the first layer 15 provides a high moisture barrier (0.50 WVTR or less)/low moisture transmission rate, over the first layer 15. Such polymer resins include: polypropylene homopolymers and copolymers, high density polyethylenes and linear low density polyethylenes.

A low density polyethylene having a high melt index (10.0 or higher) is used for the sealant layer 25 (outside layer) or second layer.

In use, the paper/coextrusion material is heated and the polymer side is placed next to the fiberglass or other insulation so as to allow the outside, low density polyethylene to adhere to the insulation. The other side of the wrap material may be printed upon using known printing techniques.

The densities of the paper layer 15 and the polymer film layer 20 of the composite wrap material 10 can be varied to control the performance of the final structure.

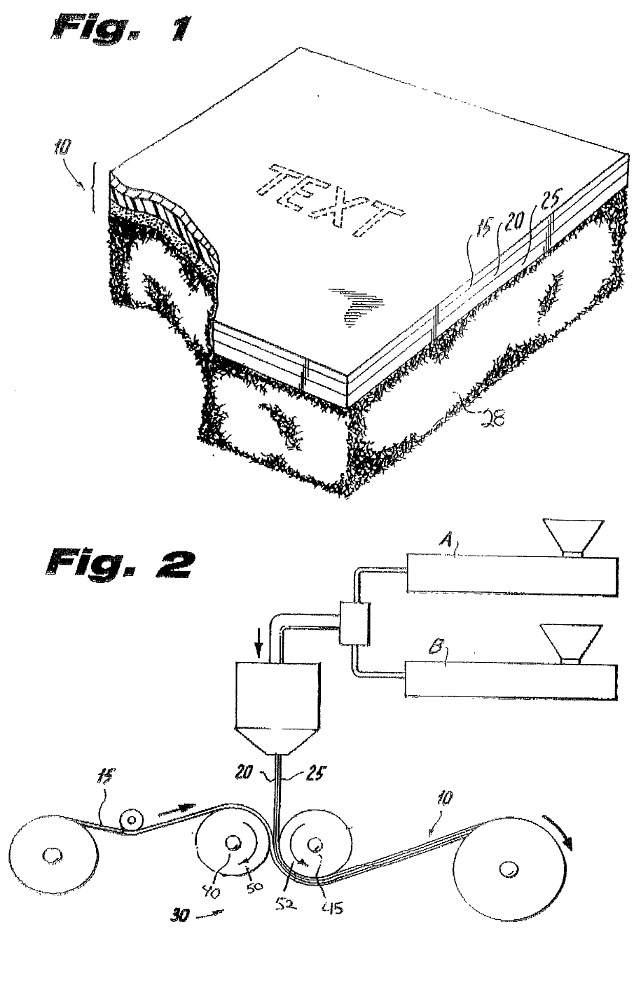

In a preferred embodiment, material 10 can be prepared by coextrusion, extrusion, or adhesive lamination or coating one or two layers of poly as schematically depicted in FIG. 2. The laminating device 30 includes two nip rollers 40, 45, that rotate in opposite directions, as shown by arrows 50, 52. In a typical set-up, the surface temperature of the chill roll 45 is controlled for cooling adhesives 20, 25. During this same process the outside of the sealant layer can also be flame- or corona-(electrically) treated to enhance adhesion or bonding to the fiberglass or other insulation.

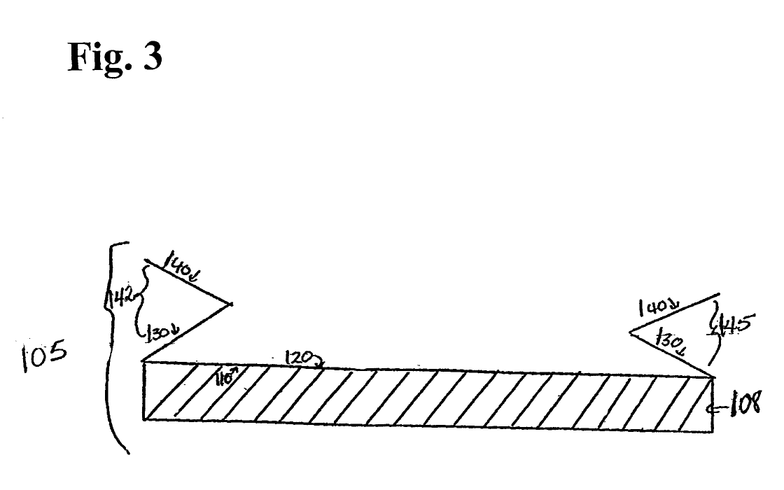

A cross-sectional view of the composite facing material (adhered on the non-printed side 110 to the fiberglass insulation material 108 after the hot rolling process) with the z-fold or flange areas 142, 145 as described herein is depicted in FIG. 3. The portions of the pre-folded facing material 105 that extend beyond the width of the fiberglass insulation material 108 are known as the z-fold areas or flanges 142, 145. These z-fold areas or flanges 142, 145 are folded lengthwise 130 toward the printed side of the facing material 120. The z-fold areas or flanges 142, 145 are folded lengthwise 140 again in the opposite direction approximately one to two inches from the first fold toward the outer edge of the facing material. This double fold forms an accordion pattern, or a double fold in the shape of the letter ‘z’, creating a two- to three-inch folded flanges or z-fold area 142, 145. The folded flanges or z-fold areas 142, 145 are pulled open by insulation installers to serve as nailer tabs, or the area on the facing material 105 through which nails or staples are driven to install the insulation to the ceilings or walls. Prior to the folding process, the portion of the facing material 105 that constitutes the flange or z-fold areas 142, 145 is coated or sprayed by any well known means with starch, silicone, mineral oil, or any substance that prevents tackiness of the z-fold areas or flanges 142, 145 during the hot rolling process and later during installation.

The invention has been described by reference to detailed examples. These examples are not meant to limit the scope of the invention. Variations within the concepts of the invention are apparent to those skilled in the art. The disclosures of the cited references throughout the application are incorporated by reference herein.

1. A coextruded coated paper material used as a facing material comprising;
a first layer comprising paper;
a second layer comprising a polymer resin material;
a third outside sealant layer comprising a low melt polymer resin;
wherein all three layers are integrally bonded together; and
a coating or spray applied to a flange or z-fold area of said facing material

2. The coated paper material of claim 1 wherein said coating or spray prevents tackiness during a hot rolling process and installation of insulation.

3. The coated paper material of claim 1 wherein said coating or spray prevents adhesion of folded areas during a hot rolling process and during installation of insulation material.

4. The coated paper material of claim 1 wherein said coating or spray comprises starch, silicone, mineral oil, or other contaminant applied to said flange or z-fold areas of said coextruded facing material.

5. The coated paper material of claim 1 wherein said coextruded material is faced with a roll or batt of insulation.

6. The coated paper material of claim 1 wherein said coating or spray on said flange or z-fold area prevents tackiness and adhesion of said z-folds during both said hot rolling process when said coextruded material is faced with a roll or batt of insulation, and during installation when said z-fold area is pulled open.

7. A poly coated paper material used as a facing material comprising:
a first layer comprised of paper;
a second layer comprised of poly and/or a third layer also comprised of poly; and
a coating or spray applied to a flange or z-fold area of said material.

8. The coated paper material of claim 7 wherein said coating or spray prevents tackiness during a hot rolling process and installation of insulation.

9. The coated paper material of claim 7 wherein said coating or spray prevents adhesion of folded areas during a hot rolling process and during installation of insulation material.

10. The coated paper material of claim 7 wherein said coating or spray comprises starch, silicone, mineral oil, or other contaminant applied to said flange or z-fold areas of said poly coated facing material.

11. The coated paper material of claim 7 wherein said poly coated material is faced with a roll or batt of insulation.

12. The coated paper material of claim 7 wherein said coating or spray on said flange or z-fold area prevents tackiness and adhesion of said z-folds during both said hot rolling process when said poly coated or coextruded material is faced with a roll or batt of insulation, and during installation when said z-fold area is pulled open to serve as a nailer tab.

13. A method for preventing tackiness of a z-fold or flange area of a composite facing material comprising:
applying or spraying a coating or spray to said z-fold or flange area of said composite facing material prior to a hot rolling process by which insulation manufacturers adhere insulation to facing material.

14. The method of claim 13 wherein said coating comprises starch, silicone, mineral oil, or other like substance.

15. The method of claim 13 wherein said applying or spraying is comprises; applying or spraying said coating on said z-fold or flange areas using an air jet, sponge, or other known means of application.

16. A composite facing material adhered on a non-printed side to fiberglass insulation material after a hot rolling process comprising;
z-fold or flange areas;
said z-fold or flange areas defined as portions of pre-folded facing material that extend beyond the width of said fiberglass insulation material;
prior to said folding process, a portion of said facing material that constitutes said flange or z-fold areas is coated or sprayed with starch, silicone, mineral oil, or any substance that prevents tackiness of said z-fold areas or flanges during said hot rolling process and later during installation.

17. A method for preparing z-fold areas or flanges of a composite facing material comprising;
coating or spraying a portion of said facing material that constitutes said z-fold area or flange with a starch, silicone, mineral oil or any substance that prevents tackiness of said z-fold areas or flanges during a hot rolling process and later during installation;
folding lengthwise toward a printed side of said facing material said z-fold areas or flanges;
folding lengthwise again in an opposite direction from said first fold said z-fold areas or flanges toward an outer edge of said facing material.

18. The method of claim 17 wherein said coating or spray is applied by an air jet, sponge, or other known means of application.

19. The method of claim 18 wherein said air jet, sponge, or other known means of application does not allow said coating to be applied beyond said z-fold area or flange.
